(19) United States
(12) Patent Application Publication
(10) Pub. No.: US 2026/0273777 A1
(43) Pub. Date: Sep. 17, 2026

(54) SELF-LUBRICATING BALL JOINT AND ROBOT

(71) Applicant: Beijing Youzhuju Network Technology Co., Ltd., Beijing (CN)

(72) Inventors: Jiawen TIAN, Beijing (CN); Zhongren CUI, Beijing (CN); Zeyu REN, Beijing (CN); Guangzeng Chen, Beijing (CN); Jiajun ZHANG, Beijing (CN); Ruoshi WEN, Beijing (CN)

(21) Appl. No.: 19/409,688

(22) Filed: Dec. 4, 2025

(30) Foreign Application Priority Data
Mar. 12, 2025 (CN) 202510293660.1

(51) Int. Cl. B25J 17/00

(52) U.S. Cl. CPC B25J 17/00

(57) ABSTRACT

Embodiments of the disclosure provide a self-lubricating ball joint and a robot. The self-lubricating ball joint includes: a connecting rod adapted to be fixedly coupled to a first component; a ball head having a through hole passing through a center of the ball head for the connecting rod to pass through, to fixedly couple the ball head to an end of the connecting rod away from the first component via a fastener; and a socket assembly slidably sleeved on the ball head and fixedly coupled to a second component, where an inner side surface of the socket assembly is arranged to be in partial contact with the ball head, and a center of the socket assembly coincides with the center of the ball head, such that the socket assembly rotates relative to the ball head around the center of the ball head with three degrees of freedom.

### CROSS-REFERENCE

This application claims priority to Chinese Patent Application No. 202510293660.1, filed on Mar. 12, 2025, and entitled “SELF-LUBRICATING BALL JOINT AND ROBOT”, the entirety of which is incorporated herein by reference.

### TECHNICAL FIELD

Example embodiments of the present disclosure generally relate to the field of robots, and in particular, to a self-lubricating ball joint and a robot.

### BACKGROUND

In modern times, many fields such as aerospace, robots, automobiles, and medical devices have put forward higher requirements for joint technologies with high precision, high flexibility, and high reliability. In the field of aerospace, the control system of an aircraft requires a ball joint to achieve precise steering and attitude control. In the field of robots, in order to enable a robot to perform various actions as flexibly as a human, the ball joint has become one of the key technologies for joint design. In the field of automobiles, the ball joint in a suspension system is critical to the driving stability and comfort of a vehicle. In the field of medical devices, in artificial joint replacement surgery, the development of ball joint technology provides a better solution for a patient to restore joint function. In order to improve the performance of the ball joint, it is necessary to optimize its structure design.

### SUMMARY

In a first aspect of the present disclosure, a self-lubricating ball joint is provided. The self-lubricating ball joint includes: a connecting rod adapted to be fixedly coupled to a first component; a ball head having a through hole passing through a center of the ball head for the connecting rod to pass through, to fixedly couple the ball head to an end of the connecting rod away from the first component via a fastener; and a socket assembly slidably sleeved on the ball head and fixedly coupled to a second component, where an inner side surface of the socket assembly is arranged to be in partial contact with the ball head, and a center of the socket assembly coincides with the center of the ball head, such that the socket assembly rotates relative to the ball head around the center of the ball head with three degrees of freedom.

In some embodiments, the socket assembly includes: a center ring having a plurality of first mounting holes distributed in a radial direction; a pair of lubricating oil rings arranged at two axial ends of the center ring, and annular inner side surfaces of the pair of lubricating oil rings being in contact with the ball head; a plurality of top supporting members, first ends of the plurality of top supporting members being adapted to be fixedly coupled to the second component, and second ends of the plurality of top supporting members being fixedly coupled to one of the pair of lubricating oil rings, close to the plurality of top supporting members; and a plurality of side supporting members respectively extending outward from an interior of the center ring through the plurality of first mounting holes to be fixedly coupled to the second component.

In some embodiments, a plurality of protrusions are arranged on the center ring in a radial direction, the plurality of protrusions are arranged to respectively extend on the center ring in a direction toward a center line of the center ring and in a direction away from the center line of the center ring, and each of the plurality of protrusions is arranged with the first mounting hole.

In some embodiments, each of the pair of lubricating oil rings includes: a main body portion, an annular inner side surface of the main body portion in an axial direction of the main body portion including a first annular inner side surface and a second annular inner side surface, where the first annular inner side surface is arranged to be in contact with the ball head, and the second annular inner side surface is closer to the other lubricating oil ring in the axial direction than the first annular inner side surface is and an inner diameter of the second annular inner side surface is larger than an inner diameter of the first annular inner side surface, to form an accommodating cavity for accommodating grease between the second annular inner side surface and the ball head; and a sealing flange extending radially outward on an outer side of one end of the main body portion away from the center ring.

In some embodiments, a plurality of second mounting holes are arranged on a surface of the main body portion facing away from the center ring.

In some embodiments, the main body portion further includes, in a circumferential direction, a plurality of notches recessed inward from a radially outer surface adapted to respectively accommodate the plurality of protrusions, to thereby restrict a movement of the center ring in the circumferential direction.

In some embodiments, each of the pair of lubricating oil rings further includes a plurality of connecting holes, and each of the pair of lubricating oil rings is fixedly coupled to corresponding one of the two axial ends of the center ring by a plurality of first locking screws passing through the respective connecting holes.

In some embodiments, each of the plurality of top supporting members has an axial hole extending in an axial direction of the top supporting member, and each of the plurality of top supporting members is arranged in the second mounting hole of the main body portion via a second locking screw passing through the axial hole.

In some embodiments, the self-lubricating ball joint further includes a pair of bushings respectively fixedly coupled to two ends of the through hole of the ball head.

In some embodiments, the connecting rod includes: a limiting piece adapted to limit the ball head; a first connecting rod arranged on a side of the limiting piece close to the ball head; and a second connecting rod fixedly coupled to the first connecting rod and extending from the first connecting rod along an axis of the first connecting rod in a direction away from the limiting piece, where a diameter of the second connecting rod is smaller than a diameter of the first connecting rod.

In some embodiments, an end of the first connecting rod close to the second connecting rod has a first engaging portion for coupling with the fastener to fasten the connecting rod in the through hole, and an end of the second connecting rod away from the first connecting rod has a second engaging portion for the second connecting rod to be fixedly coupled to the first component.

In a second aspect of the present disclosure, a robot is provided. The robot includes: a first component and a second component; and at least one self-lubricating ball joint provided according to the first aspect of the present disclosure and coupled between the first component and the second component, to enable the first component to move relative to the second component with three degrees of freedom.

It should be understood that the content described in this section is not intended to limit key features or important features of embodiments of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of embodiments of the present disclosure will become more apparent in combination with the drawings and with reference to the following detailed description. In the drawings, the same or similar reference numbers refer to the same or similar elements, where:

FIG. 1 shows a three-dimensional schematic diagram of a ball joint according to embodiments of the present disclosure;

FIG. 2 shows a schematic diagram of a ball head and a connecting rod according to embodiments of the present disclosure;

FIG. 3 shows an exploded diagram of a socket assembly according to embodiments of the present disclosure;

FIG. 4 shows a schematic diagram of a lubricating oil ring according to embodiments of the present disclosure; and

FIG. 5 shows a schematic diagram of a maximum rotation angle of a ball joint according to embodiments of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be noted that the titles of any section/sub-section provided herein are not restrictive. Various embodiments are described throughout this article, and any type of embodiment may be included under any section/sub-section. In addition, the embodiments described in any section/sub-section may be combined with any other embodiments described in the same section/sub-section and/or different section/sub-section in any manner.

In the description of embodiments of the present disclosure, the term "include " and similar terms should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other explicit and implicit definitions may also be included below. The terms "first" and "second" etc. may refer to different or same objects. Other explicit and implicit definitions may also be included below.

As mentioned above, in order to improve the performance of the ball joint, it is necessary to optimize its structural design. One solution is to provide an appropriate gap between the ball head and the socket to ensure the flexibility of the joint, while ensuring that the gap will not be too large to cause the joint to be loose and unstable. Another solution is to design a special curved surface shape in the socket to better fit the ball head, disperse pressure and improve the bearing capacity of the joint. In addition, some ball joints are also equipped with sealing devices to prevent dust, impurities, etc., from entering the joint and affecting normal operation of the joint.

In order to solve or at least partially solve the above-mentioned problems or other potential problems of the ball joint in the traditional solutions, embodiments of the present disclosure provide a self-lubricating ball joint and a robot. According to the solution of embodiments of the present disclosure, the load capacity of the ball joint is further improved by making an inner side surface of the socket into contact and fit with the ball head. Further, by arranging a center ring between a pair of lubricating oil rings, and making inner side surfaces of the lubricating oil rings into contact with the ball head for lubrication, the self-lubricating ability is improved, and smooth transmission of the ball joint is ensured even after long-time operation. Further, by reducing a width of the socket in an axial direction, the ball joint has a larger rotation angle.

The robot according to embodiments of the present disclosure may refer to any appropriate robot, for example, including but not limited to: a humanoid robot, a crawling robot, an industrial robot, a service robot, a full-automatic robot, a semi-automatic robot, a remote control robot, a robotic arm robot, etc.

For example, a humanoid robot is taken as an example to illustrate an example structure of the robot according to embodiments of the present disclosure. The humanoid robot may at least include a first component and a second component. The first component and the second component may be two connecting components that need to rotate relative to each other. Specifically, the first component and the second component may be two components of the robot, for example, two components connected by a neck joint, a shoulder joint, a hip joint, a wrist joint or an ankle joint. The first component and the second component may be connected by the ball joint according to embodiments of the present disclosure, to rotate with three degrees of freedom relative to each other. For example, a movement with three degrees of freedom may include rotations around three mutually perpendicular axes, and the three axes may include, for example, an extension axis of a connecting rod 1, and a second axis and a third axis that are perpendicular to the connecting rod 1 and perpendicular to each other.

For example, in some embodiments, the first component may be a forearm of the robot, and the second component may be a hand of the robot. Their connection design not only needs to ensure the flexibility between the components, but also needs to have certain stability and strength to cope with complex actions and loads. The concept according to the present disclosure will be described hereinafter mainly by taking the ball joint as an example. It should be understood that the situation for other types of robots is similar and will not be described separately hereinafter. In addition, the first component and the second component of the robot are described above by taking the first component as the forearm and the second component as the hand as examples. It should also be understood that the first component and the second component of the robot according to embodiments of the present disclosure may refer to any two components that need to rotate with three degrees of freedom relative to each other.

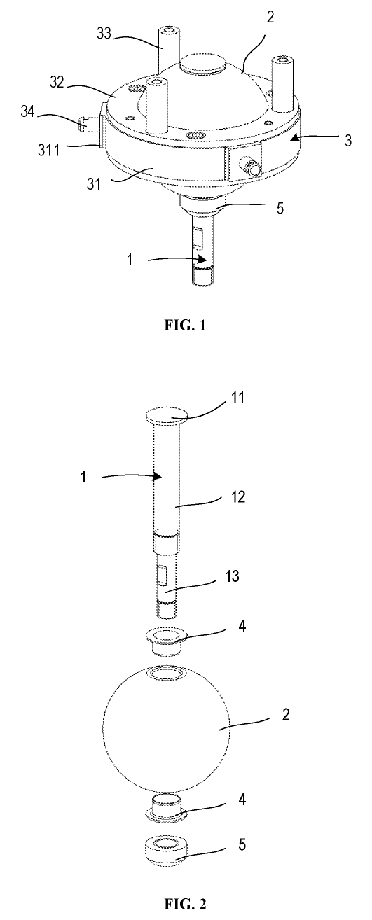

The example structure of the ball joint will be described below in conjunction with FIGS. 1 and 2. The self-lubricating ball joint according to embodiments of the present disclosure generally includes at least a connecting rod 1, a ball head 2 and a socket assembly 3. The connecting rod 1 is fixedly coupled to the first component of the robot. The ball head 2 has a through hole passing through a center of the ball head, the connecting rod 1 passes through the through hole of the ball head 2, and the ball head 2 is fixedly coupled to an end of the connecting rod 1 away from a first component by a fastener 5. For example, the fastener 5 may be a nut. In this way, the connecting rod 1 and the ball head 2 are assembled together to form a ball head end, and the ball head end is arranged in the socket assembly 3.

The socket assembly 3 is slidably sleeved on the ball head 2 and fixedly coupled to a second component of the robot. An inner side surface of the socket assembly 3 is in partial contact with the ball head 2, and a center of the socket assembly 3 coincides with a center of the ball head 2, such that the socket assembly 3 rotates relative to the ball head 2 with three degrees of freedom directions. A diameter of at least part of the inner side surface of the socket assembly 3 is the same as a diameter of the ball head 2, so that the ball head 2 may fit better with the socket assembly 3, reducing the possibility of looseness, and thereby significantly enhancing the load capacity and stability of the ball joint.

A material selection of the ball joint plays a crucial role in its performance, service life and load capacity. In order to improve the support strength of the ball joint, materials with high strength, high wear resistance and good corrosion resistance may be selected. For example, alloy steel, stainless steel, titanium alloy, etc. are selected for manufacturing the ball head and the socket assembly. In order to reduce weight, light materials such as aluminum alloy may be selected. In order to improve transmission accuracy and stability, ceramic materials may be selected to improve the hardness and wear resistance of the joint. Further, according to load requirements, the ball head 2 may be made of materials such as POM, copper alloy and aluminum alloy.

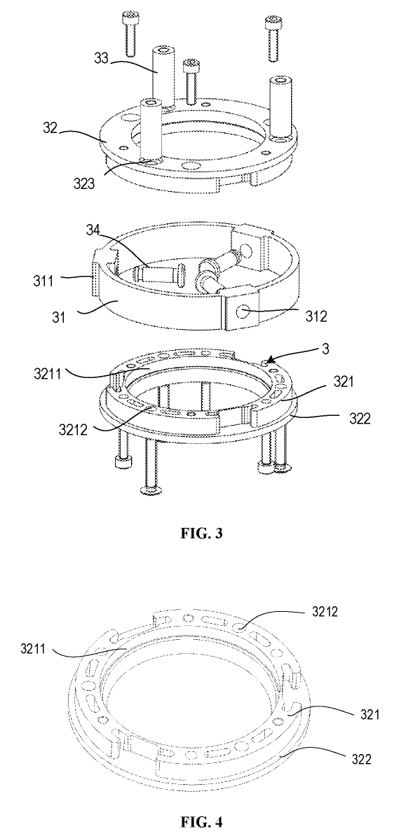

In some embodiments, as shown in FIG. 3, the socket assembly 3 includes a center ring 31, a pair of lubricating oil rings 32, a plurality of top supporting members 33 and a plurality of side supporting members 34. The center ring 31 has a plurality of first mounting holes 312 distributed in a radial direction, and the plurality of side supporting members 34 respectively extend outward from an interior of the center ring 31 through the plurality of first mounting holes 312 to be fixedly coupled to the second component. The pair of lubricating oil rings 32 are arranged at two axial ends of the center ring 31, and an inner diameter of the pair of lubricating oil rings 32 is the same as a diameter of the ball head 2. A specific structure of the lubricating oil ring 32 will be further described hereinafter.

First ends of the plurality of top supporting members 33 are adapted to be fixedly coupled to the second component, and second ends of the plurality of top supporting members 33 are fixedly coupled to one of the pair of lubricating oil rings 32 close to the plurality of top supporting members 33. The plurality of top supporting members 33 are used to fixedly couple the ball joint to the second component. For example, the number of the plurality of top supporting members 33 and the number of the plurality of side supporting members 34 may each be three. The plurality of top supporting members 33 and the plurality of side supporting members 34 may be screws. In this way, by providing the plurality of top supporting members 33 and the plurality of side supporting members 34, a connection manner of the ball joint to the second component may be selected. Specifically, according to the structure and connection position of the second component, the plurality of top supporting members 33 may be connected to one end of the second component, or the plurality of side supporting members 34 may be connected to one end of the second component, or the plurality of top supporting members 33 and the plurality of side supporting members 34 may be used together to firmly connect the ball joint to the second component, preventing looseness or falling off during movement, while being able to withstand greater loads.

In some embodiments, a plurality of protrusions 311 are arranged on the center ring 31 in a radial direction, the plurality of protrusions 311 are arranged to respectively extend on the center ring 31 in a direction toward a center line of the center ring 31 and in a direction away from the center line of the center ring 31, and each protrusion 311 is arranged with a first mounting hole 312. That is, the protrusions 311 are arranged on both an inner side surface and an outer side surface of the center ring 31. In this way, a thickness of the joint of the center ring 31 may be increased, which plays a role of reinforcement, improves the connection strength between the side supporting members 34 and the second component, and enables it to withstand greater loads and stresses.

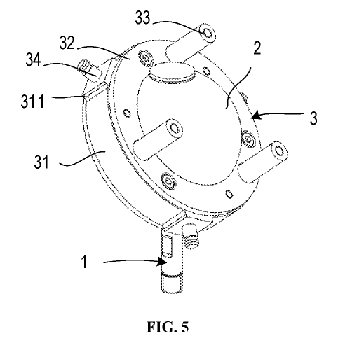

In some embodiments, as shown in FIG. 4, each lubricating oil ring 32 includes a main body portion 321 and a sealing flange 322. An annular inner side surface of the main body portion 321 in an axial direction of the main body portion 321 includes a first annular inner side surface and a second annular inner side surface, the first annular inner side surface is arranged to be in contact with the ball head 2, and the second annular inner side surface is closer to the other lubricating oil ring in the axial direction than the first annular inner side surface is and an inner diameter of the second annular inner side surface is larger than an inner diameter of the first annular inner side surface, to form an accommodating cavity 3211 for accommodating grease between the second annular inner side surface and the ball head 2. In this way, the load capacity of the joint is further improved by making the annular inner side surface of the socket assembly 3 into contact with the ball head 2, and at the same time, the grease may form a uniform lubricating film in the socket assembly 3, which covers the contact surface between the ball head 2 and the socket assembly 3, effectively reducing a direct contact between the surface of the ball head 2 and the socket assembly 3, and ensuring smooth transmission of the ball joint even after long-time operation.

The sealing flange 322 extends radially outward on an outer side of one end of the main body portion 321 away from the center ring 31. Further, an outer diameter of the sealing flange 322 is the same as an outer diameter of the center ring 31. In this way, after the pair of lubricating oil rings 32 and the center ring 31 are assembled together, an annular outer surface of the sealing flange 322 is aligned with an annular outer surface of the center ring 31. In addition, after assembly, the center ring 31 is in contact with the sealing flanges 322 located at the two axial ends, respectively.

In this way, it is ensured that the entire socket assembly 3 has a relatively small height (that is, a dimension in the axial direction of the center ring 31), so that a rotation angle of the ball head may be effectively increased without an interference between the connecting rod 1 and the socket assembly 3.

For example, in some embodiments, a height of the socket may be in a range of 20% to 40% of the diameter of the ball head. For example, the height of the socket may be about a quarter of the diameter of the ball head, so that the rotation angle of the connecting rod 1 may reach ±50°, as shown in FIG. 5. That is, an angle between a normal of the plane where the socket assembly 3 is located and an axis of the connecting rod 1 may reach ±50°, which significantly increases the range of relative motion between the first component and the second component, and improves the flexibility of the robot.

In some embodiments, as shown in FIG. 3, a plurality of second mounting holes 323 are arranged in a surface of the main body portion 321 facing away from the center ring 31, and the plurality of top supporting members 33 are arranged in the second mounting holes 323, to realize a stable connection between the plurality of top supporting members 33 and the socket assembly 3.

In some embodiments, as shown in FIGS. 3 and 4, the main body portion 321 further includes, in a circumferential direction, a plurality of notches recessed inward from a radially outer surface adapted to respectively accommodate the plurality of protrusions 311. In this way, a movement of the center ring 31 in the circumferential direction may be restricted.

In some embodiments, each lubricating oil ring 32 further includes a plurality of connecting holes 3212, and each lubricating oil ring 32 is fixedly coupled to corresponding one of the two axial ends of the center ring 31 by a plurality of first locking screws passing through the respective connecting holes 3212.

In some embodiments, each top supporting member 33 has an axial hole extending in an axial direction of the top supporting member 33, and each top supporting member 33 is arranged in the second mounting hole 323 of the main body portion 321 by a second locking screw passing through the axial hole.

Further, an installation process of the socket assembly is as follows: the plurality of side supporting members are mounted into the first mounting holes 312 of the center ring 31, and one of the lubricating oil rings 32 is combined with the center ring 31 to form a combined body. The combined body is further placed on the ball head 2 of the installed ball head end, so that the annular inner side surface of one of the lubricating oil rings 32 is in contact with the ball head 2. The accommodating cavities of the two lubricating oil rings 32 are filled with grease, the other lubricating oil ring 32 is mounted into the center ring 31 from the bottom, and the upper and lower lubricating oil rings 32 are locked with the first locking screws. Finally, the plurality of top supporting members 33 are locked with the second locking screws.

In some embodiments, as shown in FIG. 2, the self-lubricating ball joint further includes a pair of bushings 4 respectively fixedly coupled to two ends of the through hole of the ball head 2. The bushings are arranged between the ball head 2 and the connecting rod 1 of the ball joint to ensure the stability of the ball joint during movement.

In some embodiments, as shown in FIG. 2, the connecting rod 1 includes a limiting piece 11, a first connecting rod 12 and a second connecting rod 13. The limiting piece 11 is adapted to limit the ball head 2, the first connecting rod 12 is arranged on a side of the limiting piece 11 close to the ball head 2, the second connecting rod 13 is fixedly coupled to the first connecting rod 12 and extends from the first connecting rod 12 along an axis of the first connecting rod 12 in a direction away from the limiting piece 11, and a diameter of the second connecting rod 13 is smaller than a diameter of the first connecting rod 12.

In some embodiments, as shown in FIG. 2, an end of the first connecting rod 12 close to the second connecting rod 13 has a first engaging portion for the fastener 5 to be arranged therein. In some embodiments, the first engaging portion may be a threaded portion, which may be coupled with the fastener 5 to fasten the connecting rod 1 in the through hole. An end of the second connecting rod 13 away from the first connecting rod 12 has a second engaging portion for the second connecting rod 13 to be fixedly coupled to the first component. In this way, the ball head 2 is limited to the end of the first connecting rod 12, and the ball head 2 and the connecting rod 1 are conveniently disassembled and assembled through the cooperation of the fastener and limiting ring grooves.

The implementations of the present disclosure have been described above. The above description is illustrative, not exhaustive, and is not limited to the disclosed implementations. Many modifications and changes will be apparent to those of ordinary skill in the art without departing from the scope and spirit of the described implementations. The terms used herein are intended to best explain the principles, practical applications, or improvements to the technology in the market of the implementations, or to enable other ordinary skilled in the art to understand the implementations disclosed herein.

1. A self-lubricating ball joint, comprising:
a connecting rod adapted to be fixedly coupled to a first component;
a ball head having a through hole passing through a center of the ball head for the connecting rod to pass through, to fixedly couple the ball head to an end of the connecting rod away from the first component via a fastener; and
a socket assembly slidably sleeved on the ball head and fixedly coupled to a second component,
wherein an inner side surface of the socket assembly is arranged to be in partial contact with the ball head, and a center of the socket assembly coincides with the center of the ball head, such that the socket assembly rotates relative to the ball head around the center of the ball head with three degrees of freedom.

2. The self-lubricating ball joint of claim 1, wherein the socket assembly comprises:
a center ring having a plurality of first mounting holes distributed in a radial direction;
a pair of lubricating oil rings arranged at two axial ends of the center ring, and annular inner side surfaces of the pair of lubricating oil rings being in contact with the ball head;
a plurality of top supporting members, first ends of the plurality of top supporting members being adapted to be fixedly coupled to the second component, and second ends of the plurality of top supporting members being fixedly coupled to one of the pair of lubricating oil rings close to the plurality of top supporting members; and
a plurality of side supporting members respectively extending outward from an interior of the center ring through the plurality of first mounting holes to be fixedly coupled to the second component.

3. The self-lubricating ball joint of claim 2, wherein a plurality of protrusions are arranged on the center ring in a radial direction, the plurality of protrusions are arranged to respectively extend on the center ring in a direction toward a center line of the center ring and in a direction away from the center line of the center ring, and each of the plurality of protrusions is arranged with the first mounting hole.

4. The self-lubricating ball joint of claim 3, wherein each of the pair of lubricating oil rings comprises:
a main body portion, an annular inner side surface of the main body portion in an axial direction of the main body portion comprising a first annular inner side surface and a second annular inner side surface, wherein the first annular inner side surface is arranged to be in contact with the ball head, and the second annular inner side surface is closer to the other lubricating oil ring in the axial direction than the first annular inner side surface is and an inner diameter of the second annular inner side surface is larger than an inner diameter of the first annular inner side surface, to form an accommodating cavity for accommodating grease between the second annular inner side surface and the ball head; and
a sealing flange extending radially outward on an outer side of one end of the main body portion away from the center ring.

5. The self-lubricating ball joint of claim 4, wherein a plurality of second mounting holes are arranged on a surface of the main body portion facing away from the center ring.

6. The self-lubricating ball joint of claim 4, wherein the main body portion further comprises, in a circumferential direction, a plurality of notches recessed inward from a radially outer surface adapted to respectively accommodate the plurality of protrusions, to thereby restrict a movement of the center ring in the circumferential direction.

7. The self-lubricating ball joint of claim 4, wherein each of the pair of lubricating oil rings further comprises a plurality of connecting holes, and each of the pair of lubricating oil rings is fixedly coupled to corresponding one of the two axial ends of the center ring by a plurality of first locking screws passing through the respective connecting holes.

8. The self-lubricating ball joint of claim 5, wherein each of the plurality of top supporting member has an axial hole extending in an axial direction of the top supporting member, and each of the plurality of top supporting members is arranged in the second mounting hole of the main body portion by a second locking screw passing through the axial hole.

9. The self-lubricating ball joint of claim 1, further comprising:
a pair of bushings respectively fixedly coupled to two ends of the through hole of the ball head.

10. The self-lubricating ball joint of claim 8, wherein the connecting rod comprises:
a limiting piece adapted to limit the ball head;
a first connecting rod arranged on a side of the limiting piece close to the ball head; and
a second connecting rod fixedly coupled to the first connecting rod and extending from the first connecting rod along an axis of the first connecting rod in a direction away from the limiting piece, wherein a diameter of the second connecting rod is smaller than a diameter of the first connecting rod.

11. The self-lubricating ball joint of claim 9, wherein an end of the first connecting rod close to the second connecting rod has a first engaging portion for coupling with the fastener to fasten the connecting rod in the through hole, and an end of the second connecting rod away from the first connecting rod has a second engaging portion for the second connecting rod to be fixedly coupled to the first component.

12. A robot, comprising:
a first component and a second component; and
at least one self-lubricating ball coupled between the first component and the second component, to enable the first component to move relative to the second component with three degrees of freedom, wherein at least one self-lubricating ball joint comprises:
a connecting rod adapted to be fixedly coupled to a first component;
a ball head having a through hole passing through a center of the ball head for the connecting rod to pass through, to fixedly couple the ball head to an end of the connecting rod away from the first component via a fastener; and
a socket assembly slidably sleeved on the ball head and fixedly coupled to a second component,
wherein an inner side surface of the socket assembly is arranged to be in partial contact with the ball head, and a center of the socket assembly coincides with the center of the ball head, such that the socket assembly rotates relative to the ball head around the center of the ball head with three degrees of freedom.

13. The robot of claim 12, wherein the socket assembly comprises:
a center ring having a plurality of first mounting holes distributed in a radial direction;
a pair of lubricating oil rings arranged at two axial ends of the center ring, and annular inner side surfaces of the pair of lubricating oil rings being in contact with the ball head;
a plurality of top supporting members, first ends of the plurality of top supporting members being adapted to be fixedly coupled to the second component, and second ends of the plurality of top supporting members being fixedly coupled to one of the pair of lubricating oil rings close to the plurality of top supporting members; and
a plurality of side supporting members respectively extending outward from an interior of the center ring through the plurality of first mounting holes to be fixedly coupled to the second component.

14. The robot of claim 13, wherein a plurality of protrusions are arranged on the center ring in a radial direction, the plurality of protrusions are arranged to respectively extend on the center ring in a direction toward a center line of the center ring and in a direction away from the center line of the center ring, and each of the plurality of protrusions is arranged with the first mounting hole.

15. The robot of claim 14, wherein each of the pair of lubricating oil rings comprises:
a main body portion, an annular inner side surface of the main body portion in an axial direction of the main body portion comprising a first annular inner side surface and a second annular inner side surface, wherein the first annular inner side surface is arranged to be in contact with the ball head, and the second annular inner side surface is closer to the other lubricating oil ring in the axial direction than the first annular inner side surface is and an inner diameter of the second annular inner side surface is larger than an inner diameter of the first annular inner side surface, to form an accommodating cavity for accommodating grease between the second annular inner side surface and the ball head; and
a sealing flange extending radially outward on an outer side of one end of the main body portion away from the center ring.

16. The robot of claim 15, wherein a plurality of second mounting holes are arranged on a surface of the main body portion facing away from the center ring.

17. The robot of claim 15, wherein the main body portion further comprises, in a circumferential direction, a plurality of notches recessed inward from a radially outer surface adapted to respectively accommodate the plurality of protrusions, to thereby restrict a movement of the center ring in the circumferential direction.

18. The robot of claim 15, wherein each of the pair of lubricating oil rings further comprises a plurality of connecting holes, and each of the pair of lubricating oil rings is fixedly coupled to corresponding one of the two axial ends of the center ring by a plurality of first locking screws passing through the respective connecting holes.

19. The robot of claim 16, wherein each of the plurality of top supporting member has an axial hole extending in an axial direction of the top supporting member, and each of the plurality of top supporting members is arranged in the second mounting hole of the main body portion by a second locking screw passing through the axial hole.

20. The robot of claim 12, further comprising:
a pair of bushings respectively fixedly coupled to two ends of the through hole of the ball head.
